(19) United States
(12) Patent Application Publication
(10) Pub. No.: US 2015/0360988 A1
(43) Pub. Date: Dec. 17, 2015

(54) METHOD FOR IMPROVING THE PERCENT RECOVERY AND WATER QUALITY IN HIGH TOTAL HARDNESS WATER

(71) Applicant: Chevron U.S.A. Inc., San Ramon, CA (US)

(72) Inventors: Fan-Sheng Teddy Tao, Missouri City, TX (US); Ronald David Hobbs, Wharton, TX (US)

(21) Appl. No.: 14/837,368

(22) Filed: Aug. 27, 2015

Related U.S. Application Data
(63) Continuation-in-part of application No. 13/836,317, filed on Mar. 15, 2013.
(60) Provisional application No. 62/198,299, filed on Jul. 29, 2015.
(60) Provisional application No. 62/198,291, filed on Jul. 29, 2015.

(51) Int. Cl. C02F 9/00; C02F 5/06; C02F 5/02; C02F 1/66; C02F 1/44; C02F 1/42

(52) U.S. Cl. CPC C02F 9/00; C02F 1/441; C02F 1/42; C02F 5/02; C02F 1/66; C02F 5/06; C02F 2303/22; C02F 2001/007

(57) ABSTRACT

A method is disclosed for improving the percent recovery and water quality in water with high levels of hardness. Embodiments of the method include receiving a produced water composition, partially softening the water composition, and directing the partially softened water composition through at least one reverse osmosis unit. The method may be used to purify and clarify produced water from oil and gas operations for use in boilers or once-through steam generators.

### CROSS-REFERENCE TO RELATED APPLICATION

The present application is a continuation-in-part application of and claims the benefit under 35 USC 120 of U.S. application Ser. No. 13/836,317, with a filing date of Mar. 15, 2013. This application also claims benefit under 35 USC 119 of U.S. Provisional Patent Application Nos. 62/198,299 and 62/198,291, both with a filing date of Jul. 29, 2015. This application claims priority to and benefits from the foregoing, the disclosures of which are incorporated herein by reference.

### TECHNICAL FIELD

The present disclosure generally relates to methods for purifying and clarifying water. Specifically, an embodiment of the method is directed to purifying water with high total hardness levels produced from oil and gas operations to result in cleaner, boiler or drinking quality water.

### BACKGROUND

Fluid recovered from an oil and gas production well (production or produced fluid) comprises a mixture of hydrocarbons and water. The mixture is generally seperated into gas, oil and water phases, and these individual phases are further processed or purified. In order to reduce operating costs, water recovered from production wells can be recycled into well operations. In one case, the recovered water can be used in steam flooding operations. However, steam flooding requires removing the hardness from water down to less than 1.0 ppm. Depending on the reservoir, the hardness of recovered water can range from around 20 to over 10,000 ppm.

Conventional methods of water softening include reducing hardness using alkaline materials to raise pH, thereby causing precipitation of the hard materials. However, this method is expensive because it uses a large amount of alkaline chemicals and leaves a large amount of precipitates to dispose of Another method uses ion-exchange resins, such as strong acid cation (SAC) exchange resins, to soften water. These ion-exchange resins can also be costly to buy and run, and many units may be needed. While these methods work at lower levels of hardness, these methods are not economical at higher levels of hardness because they use a significant amount of salt for regeneration. Further, it is difficult to soften the higher ranges of hardness found in recovered water by using these conventional water softeners, especially when the total dissolved solids (TDS) exceed 5,000 ppm level. In the case of high TDS, a weak acid softener (WAC) is usually used. WAC softeners use acid for regeneration, which can also become expensive at higher levels of hardness due to the use and disposal of acids.

For instance, a high pressure boiler requires a feed water with total dissolved solids (TDS) below 20 ppm and close to zero levels of hardness (calcium, magnesium, strontium and barium, for example). Conventionally, a two pass RO membrane system is required to achieve such a low TDS and hardness level for the boilers. For example, produced water with approximately 8000 ppm of TDS and 4000 ppm of hardness could reach a TDS below 20 ppm with a two-pass RO membrane system. However, the percent recovery for producing the permeate water with this system would only reach about 55%. The other 45% would be concentrate water that is unusable in a boiler system.

### SUMMARY

Embodiments of the disclosure include methods to reduce the hardness and TDS in produced water. One embodiment of the disclosure is a method of improving the percent recovery in water with high levels of hardness, the method comprising: a) receiving a produced water composition, b) partially softening the water composition, c) adding an antiscalant to the partially softened water composition, and c) directing the partially softened water composition through at least one reverse osmosis module. In embodiments of the disclosure, the effluent is directed from the reverse osmosis module to a boiler or a once-through steam generator. The produced water may be pretreated prior to being partially softened. For example, pretreatment may include filtering large particles out of the produced water, and removing gas and oil. The method may additionally include a decarbonator unit. The partially softened water may be cooled prior to directing the partially softened water composition through at least one reverse osmosis module or heated prior to partial water softening. In some embodiments, the water is cooled to less than 100° C., less than 95° C., less than 93° C., less than 90° C., or less than 80° C.

In embodiments of the disclosure only one RO module is used. In other embodiments of the disclosure, more than one RO module is used. In a specific embodiment of the disclosure, two RO modules are used. In some embodiments, the concentrate (reject) stream from the second RO module may be recycled back into the influx of the first RO module. The RO membrane may be a reverse osmosis membrane (RO), or a nanofiltration (NF) membrane. In embodiments of the disclosure, the RO membrane is a high recovery RO membrane. In some embodiments, the RO membrane is a high temperature membrane. The high temperature membrane unit could be a reverse osmosis (RO) membrane unit, or a nanofiltation (NF) membrane unit. For example, the high temperature reverse osmosis unit can have a maximum temperature of between 120 to 210° F.

In embodiments of the disclosure, partially softening the water comprises using a chemical softener or an ion exchange resin based water softener. In embodiments, the chemical softener is lime, soda ash, or a combination thereof. In other embodiments of the disclosure, the water softener is a strong acid cation softener or a weak acid cation softener. In some embodiments of the disclosure, partially softening the water comprises reducing the hardness of the produced water composition by about 30-70%, about 40-80%, about 50-70%, or about 50-60%. In some embodiments of the disclosure, partially softening the water composition comprises reducing the hardness of the produced water to at most about 10, about 25, about 50, about 100, about 200, about 300, about 400, about 500, about 750, about 1000, about 1500, about 2000, about 2500, about 3000, about 4000 or about 5000 ppm. In specific embodiments, the produced water composition comprises a TDS of greater than greater than 3000, greater than 4000, greater than 5000, greater than 6000, or greater than 7000.

In one aspect, methods and mechanisms for operating a membrane purification system include passing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series; selecting a membrane element in contact with the retentate fraction as feed that has a turbidity that exceeds 0.5 NTU units; treating at least a portion of the feed retentate fraction to the select membrane element and restoring the turbidity of the feed retentate fraction to no more than 0.5 NTU units. In one embodiment, the membrane modules for producing purified water include RO (reverse osmosis) membranes.

In one embodiment, treating at least a portion of the retentate fraction includes settling the portion in a clarification module. Treating at least a portion of the retentate fraction may include adding a coagulant to the clarification module. Treating at least a portion of the retentate fraction may include filtering clarified water from the clarification module. Treating at least a portion of the retentate fraction may include adding fresh or purified water to the clarification module.

In one embodiment, treating at least a portion of the retentate fraction includes adding fresh or purified water to the retentate fraction in contact with a select membrane element. In one embodiment, treating at least a portion of the retentate fraction includes adjusting the pH of the retentate fraction in contact with the select membrane element. In one embodiment, treating at least a portion of the retentate fraction includes recycling at least a portion of the retentate fraction in contact with the select membrane. In some such embodiments, the treatment produces a treated fraction having a turbidity of no more than 0.5 NTU units.

In one embodiment, methods and mechanisms for operating a membrane purification system include directing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series; treating the retentate feed fraction to each membrane element in the module to reduce the fouling tendency of each of the membrane elements; and recovering a purified water from the membrane module.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a flow diagram of an embodiment of the invention;

FIG. 2 is an example of a system of the disclosure; and

FIG. 3 is a flow diagram illustrating the embodiment of retentate treating.

### DETAILED DESCRIPTION

Aspects of the present invention describe a method for purifying water with high levels of hardness. An embodiment of the disclosure is a method of using RO membranes with partially softened water to reduce the total hardness and total dissolved solids (TDS) of the water, and to produce a high quality water for various purposes.

As used herein, the term “equal” refers to equal values or values within the standard of error of measuring such values. The term “substantially equal,” or “about” as used herein, refers to an amount that is within 3% of the value recited.

As used herein, “a” or “an” means “at least one” or “one or more” unless otherwise indicated.

“Total dissolved solids” or TDS refers to inorganic salts (e.g., calcium, magnesium, potassium, sodium, bicarbonates, chlorides, and sulfates) and some small amounts of organic matter that are dissolved in water.

“Hardness” as used herein, refers to the concentration of multivalent cations, represented in parts per million (ppm). Typically the multivalent cations are calcium, magnesium, strontium and barium. The total hardness is a summation of calcium, magnesium, strontium, and barium ions in terms of calcium carbonate equivalent values. “High hardness,” as referred to herein, refers to water with a hardness of over 1000 ppm, over 2000 ppm, over 3000 ppm, over 4000 ppm, over 5000 ppm, over 6000 ppm, over 7000 ppm, over 8000 ppm, over 9000 ppm, over 10,000 ppm, over 11,000 ppm, or over 12,000 ppm calcium carbonate equivalent.

“Water softening,” as used herein, refers to removing hardness from the water. “Partial water softening,” as used herein, refers to removing at most 30%, at most 40%, at most 50%, at most 60%, or at most 70% of the hardness from the water. Partial water softening can result in a water that has at least about 10, about 25, about 50, about 75, about 100, about 200, about 300, about 400, about 500 ppm, about 1000, ppm, about 1500 ppm, about 2000 ppm, about 2500 ppm, about 3000 ppm, about 4000 ppm, about 5000 ppm, about 6000 ppm, or about 7000 ppm hardness.

As used herein “boiler quality water” refers to water with TDS less than 20 and hardness levels less than 0.5 ppm, or equal to 0.0 ppm. “Once-through steam generator quality water” refers to water with hardness levels less than 0.5 ppm.

“Produced water” refers to water that is produced along with oil or gas in an oil or gas recovery process.

“Membrane filtration” refers to a separation process with the use of at least a membrane to act as a filter that would let water flow through, while it catches suspended solids and other substances. In the membrane filtration modules and driven by any of pressure, vacuum or electrical force (electro-dialysis or ED), part of the liquid passes through the membrane. This fraction is called “permeate” or “filtrate”, while the fraction that does not pass through the membrane is called “retentate” or “concentrate”.

“Microfiltration” (MF) refers to a low pressure (e.g., 5 to 45 psi or 0.34 to 3 bar) membrane filtration process for the retention of suspended material. Microfiltration removes particles of 50 nm or larger. Smaller particles (salts, sugars and proteins, for example) pass through the membrane.

“Ultrafiltration” (UF) refers to a medium pressure (7 to 150 psi or 0.48 to 10 bar) membrane filtration process, for the retention of colloids, biological matters, etc. Ultrafiltration removes particles of roughly 3 nm or larger.

“Nanofiltration” (NF) refers to a membrane filtration process with operating pressure of 120 to 600 psi (or 8 to 41 bar), that would allow water and monovalent ions as well as low molecular weight substances (e.g., less than 250 Daltons) to pass through the membranes. Nanofiltration removes particles of 1 nm or larger. Divalent or multivalent ions and salts are retained.

“Reverse Osmosis” (RO) filtration refers to a high pressure membrane filtration process (300 to 850 psi or 21 to 59 bar, but can be greater than 1000 psi) that retains almost all particles and ionic species and substances with molecular weight over 50 Dalton, while allowing water and some organic molecules to pass through. Reverse osmosis removes particles larger than 0.1 nm.

With regard to filter or membrane operation, “retentate” refers to that which is retained (or rejected) by the filter or porous membrane, and “permeate” refers to that which passes through the filter or porous membrane. Unless the context recommends an alternative meaning, the terms “concentrate”, “concentrate stream”, “reject stream” and “retentate stream” are synonymous with “retentate”. Likewise, the terms “filtrate”, “filtrate stream” and “permeate stream” are synonymous with “permeate”.

“Hydraulic retention time” (HRT) refers to a measure of the average length of time that a liquid remains in a holding vessel (e.g. clarification module). Hydraulic retention time is the volume of the clarification module divided by the influent flowrate:

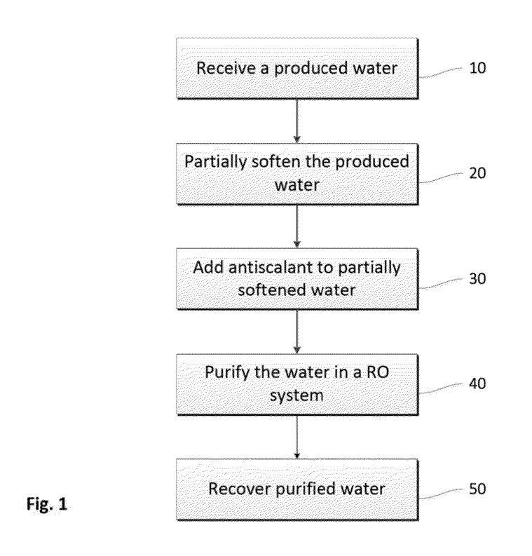

FIG. 1 illustrates an embodiment of the disclosure. First produced water is received. The produced water may have been previously pretreated to remove gas, oil, and larger particles. The produced water is then partially softened, after which antiscalant is added to the partially softened water, and the partially softened water is then run through a reverse osmosis system. The reverse osmosis system may include one or more reverse osmosis modules. In an embodiment of the invention, two RO modules are used. In the case of using more than one RO module, the reject water from the second RO module may be recycled back into the influx of the first RO module. In another embodiment, the RO module includes reverse osmosis/nanofiltrate (RO/NF) membranes.

An embodiment of the disclosure is purifying high hardness water down to boiler quality water. For example, produced water from one type of reservoir consists of approximately 3,800 ppm of total hardness, while steamflooding requires a hardness of less than 1.0 ppm. Embodiments of the disclosure use partial water softening followed by one or more RO membranes. The RO membranes may be high recovery RO membranes.

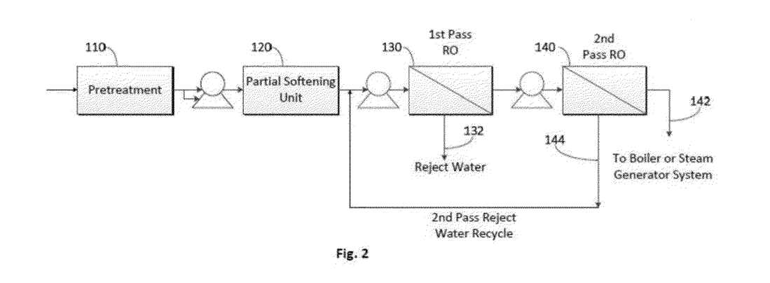

FIG. 2 illustrates an embodiment of the disclosure. Prior to softening the water, oil, gas and solids may be removed from the production fluids in pretreatment. This process can include a clarification module (e.g. holding tank) followed by flotation units and filters. It is anticipated that a flotation unit can remove up to about 95% of oil and some of the gases, such as hydrogen sulfide and carbon dioxide, from water. An ultra-filtration unit, such as a ceramic UF membrane unit may also be used prior to the softening and RO system of the current disclosure. The water may also be heated or cooled prior to entering the softening system (chemical or softener based), or after going through the softening system and before entering the RO system. For example, the water may be cooled to lower than 113° F. (45° C.) prior to going through the RO system but after going through the softening system. As another example, the water may be heated prior to chemical softening methods. After pretreatment, the produced water is then partially softened in a partial softening unit. The unit may use chemical softening, or an ion-exchange resin based softening unit.

In the process, produced water is pretreated to remove particulates and oil. Pretreatment processes may include one or more of filtering, deoiling, flotation, coagulation and precipitation, and pH adjustment.

A media filter is a type of filter that uses a bed of one or more of nutshell filter media, oyster shell filter media, sand, peat, shredded tires, foam, crushed glass, geo-textile fabric, crushed granite or other material to filter water as at least a part of the pretreatment process. An exemplary media filter includes size graded media within the filter, with water passing through the filter contacting media of decreasing size and/or increasing adsorption in passage through the filter.

A pre-treatment filtering step may be employed to remove a large proportion of oil, particulates and other contaminants from the produced water, e.g., particulates that are more than 2 μm in size. Any filter media suitable for removal of the target contaminant or contaminants may be used so long as it is also suitable for use in a filter bed, e.g., nutshell filter media, such as media made from English walnut shells and black walnut shells. Nutshell filter media is known for its affinity for both water and oil, making it a desirable filter media that is typically used for the removal of oil from water and wastewater. Conventional nutshell filters include pressurized deep bed applications in which the water is forced through a bed depth. Periodic backwashes are also routinely conducted to regenerate the bed. Typical backwash methods include expanding or turning the bed by imparting energy to the bed.

In one embodiment, oyster shells are useful, either alone or in combination with nut shell filtering, for removing water soluble organic contaminants and BTEX (benzene, toluene, ethyl benzene and xylene) contaminants from the produced water. In one embodiment of a filter system with oyster shell material, the produced water feed stream is introduced at the top of a packed column containing the shell material, and the outlet stream is collected at the bottom of the column. In one embodiment with the use of oyster shell, CaCO₃ may be added to the produced water outlet as more than 90% of oyster shell component is CaCO₃. Additionally the pH may be adjusted as the shells supply sufficient alkalinity to enhance the pH. Furthermore, the use of oyster shell removes phosphorous in the produced water by producing calcium phosphate precipitation.

In one embodiment with a produced water having a pH of greater than 9, the removal efficiency ranges from 70-90% for BTEX, phenol, and phosphorous for hydraulic retention time (HRT) of at least 2 hours. The removal efficiency is at least 85% for HRT of at least 4 hours.

Membrane purification of clarified water may be improved by further clarifying the produced water using ultrafiltration. For example, particulates present in the produced water, or particulates formed during one or more of softening, seeding, nutshell filtering and oyster shell filtering may be further removed by a preliminary ultrafiltration prior to membrane purification of the clarified water. An ultrafiltration step produces a clarified water containing particulates that are at most 10 μm in size in one embodiment; at most 5 μm in size in a second embodiment; and at most 2 μm in size in a third embodiment. Ultrafiltration may also remove at least a portion of oil (e.g. free oil) from the produced water; the clarified water after ultrafiltration contains at most 50 ppm oil in one embodiment; at most 20 ppm in a second embodiment; at most 5 ppm in a third embodiment; and at most 2 ppm in a fourth embodiment.

In some embodiments, the produced water feed may be deoiled before pre-treatment. Deoiling processes are known. The deoiling process may comprise chemical and/or mechanical means, or combinations thereof. Suitable chemical processes include, for example, use of emulsion breakers, reverse breakers, sorbents, specialty chemicals or combinations thereof. Emulsion breakers are designed to remove oil from a water continuous phase, while reverse breakers are designed to remove oil from a water continuous matrix. The inclusion of sorbents is to remove both submicron oil and/or emulsified oils from the water. An alternate embodiment allows for the use of specialty chemicals to enhance the oil/water separation. Such specialty chemicals may be added prior to or directly to a flotation step in the process. Mechanical means may involve membranes or other separation devices. In the case of membranes, ceramic or polymeric membranes may be used, and if the latter, the polymeric membranes may be microfilters, ultrafilters, nanofilters, or any combinations thereof. Mechanical means may also involve the use of centrifugal separators or cyclonic separators.

Produced water following the deoiling treatment contains at most 50 ppm oil (e.g. free oil) in one embodiment; at most 20 ppm in a second embodiment; at most 5 ppm in a third embodiment; and at most 2 ppm in a fourth embodiment. It is anticipated that a flotation unit can remove up to about 95% of oil and some of the gases, such as hydrogen sulfide and carbon dioxide, from water.

In one embodiment, the pretreatment process includes using a clarification module, optionally followed by flotation units and filters. The clarification module has sufficient capacity to provide the hydraulic retention time needed for separating oil and particulates from the water. In one embodiment, the clarification module has a hydraulic retention time, based on the volumetric flow rate of produced water to the module, of greater than 1 minute. In one embodiment instead of or in addition to deoiling, a skimming process may be used to remove the oil layer from the water; clarified water is also produced, leaving a sludge material in the clarification module for separate removal. A subsequent filtering step through a bed of an adsorbent such as clay, diatomaceous earth, oyster shell, or a nutshell filter may be used to remove the last traces of oil in the produced water.

The settling step, optionally followed by filtering, produces clarified water having a turbidity of no more than 1.5 NTU unit in one embodiment; no more than 1.0 NTU unit in a second embodiment; no more than 0.5 NTU unit in a third embodiment; and no more than 0.2 NTU unit in a fourth embodiment.

In one embodiment, the pre-treatment process includes an optional floatation process for removing oil and particulates. Flotation methods for water treatment are known. In general, they involve incorporating an adequate amount of gas into the liquid stream as small bubbles in order to provide the required physical contact between the surface of the particles of foreign matter, e.g. oil droplets or suspended solid particles, and the surface of the gas bubbles. Flotation is thus influenced by the collision between bubbles and the particles of foreign matter, the formation of flocs of particles and the adsorption of bubbles onto the particles and the floc structures. The bubble/particle interactions are governed by the surface chemistry of the system and it will be appreciated that on contact these surfaces must adhere rather than be repulsed. Separation of the oil and particulates from the water generally occur in a vessel. A sufficiently large quiescent flotation region is provided in the vessel so that the particles/gas bubbles can rise to the surface of the liquid and be removed.

The above pretreatment steps are conducted at a temperature in a range from 20° C. to 200° C. in one embodiment; from 100° C. to 200° C. in a second embodiment; and from 120° C. to 200° C. in a third embodiment.

Pretreated water from the one or more pretreatment steps contains particulates that are at most 10 μm in size in one embodiment; at most 5 μm in size in a second embodiment; and at most 2 μm in size in a third embodiment. During pretreatment, at least a portion of oil (e.g. free oil) is removed from the produced water; the pretreated water contains at most 50 ppm oil in one embodiment; at most 20 ppm in a second embodiment; at most 5 ppm in a third embodiment; and at most 2 ppm in a fourth embodiment.

The hardness contained in the pretreated water is sufficiently high to decrease separation performance of the following RO membrane separation; a portion of the hardness in the pretreated water is removed in a following partial softening step. The hardness of the pretreated water can range from around 20 to over 10,000 ppm prior to softening.

In embodiments of the disclosure, partial softening is achieved through the use of an ion exchange water softener. Softeners include ion-exchange resins in which multivalent ions are exchanged for ions located on the resins, such as Na⁺. Water softeners include weak acid cation (WAC) and strong acid cation (SAC) softeners, either of which may be used in embodiments of this disclosure. In an embodiment of the disclosure, no WAC softeners are used and approximately half the number of SAC softener units is used than what would be used for full softening of the water.

Softening processes using a chemical treatment for removing hardness from produced water are known. For example, partial softening could be achieved by the addition of sodium carbonate, sodium bi-carbonate, lime, magnesium salts, caustic, or combination of these salts.

One example of a commercial chemical softening process is a hot or warm lime softening process. An exemplary warm lime process operates at near atmospheric pressure and a temperature between about 150° F. to about 200° F. in one embodiment, between about 150° F. to about 180° F. in a second embodiment. In the case of chemical softening, the chemicals cause a partial precipitation of the hardness materials from the water, which may then be followed by thickener unit and/or a clarification unit prior to entering the membrane modules. Thickening units are used for promoting precipitation of the solids. For handling the oily produced water, thickening units promote the separation of oil from water. These units may have means to promote thickening of the solids, while others use recirculation of solids to provide seeding to the incoming chemically treated fluids. A coagulation chemical may be added to promote the precipitations. A clarifier unit takes the upper layer of water (after solid separation) to be further clarified. Some clarifier units may be equipped with incline baffles near the top of the tank to coagulate and settle the residual solids.

In one embodiment prior to the membrane purification step, the pH of the produced water may be adjusted depending on the quality of the produced water feed and/or the type of membrane purification employed. The pH is adjusted to about 3 to 9 to reduce scaling in the membrane in one embodiment; from 5 to 7.9 in a second embodiment; and from 9 to 11.5 in a third embodiment. In yet another embodiment, the pH of the produced water is adjusted to cause seeding, i.e., precipitation of hardness materials, as well as oil, silt, solids and biospecies in the produced water.

Seeding involves supplying an additive to cause some of the ionic species in the produced water to form insoluble particulates. While settling, these insoluble particulates increase in size by adsorbing other insoluble and nearly insoluble ions as well as the other contaminants in the produced water, carrying all to the bottom of a clarification module and leaving behind purified produced water with reduced hardness. In one embodiment, an alkaline chemical is added to the produced water to initiate the seeding process. Illustrative, non-limiting alkaline chemicals include caustic or sodium hydroxide; soda ash or sodium carbonate in anhydrous or in one or more of the hydrated forms; lime or one or more of its constituents, including calcium oxide, calcium hydroxide and calcium carbonate in any of the various anhydrous or hydrated forms in which these materials occur; and magnesium oxide.

In one embodiment, sufficient alkaline chemical is added to the produced water to increase the pH of the water by at most 2 numbers; in another embodiment, by at most 1 number. In one embodiment, sufficient alkaline chemical is added to a produced water to yield produced water having an NTU value of greater than 2.5; in another embodiment in a range from 2.5 to 1000. The produced water in combination with the alkaline chemical is permitted to settle for a sufficient time to produce clarified water having a turbidity of no more than 1.5 NTU unit in one embodiment; no more than 1.0 NTU unit in a second embodiment; no more than 0.5 NTU unit in a third embodiment; and no more than 0.2 NTU unit in a fourth embodiment.

If present, particulates in the clarified water are at most 5 μm in size in one embodiment; and at most 2 μm in size in a second embodiment. The clarified water contains less than 10 ppm oil in one embodiment; less than 5 ppm oil in a second embodiment; and less than 2 ppm oil in a third embodiment. The clarified water has a turbidity of no more than 1.5 NTU unit in one embodiment; no more than 1.0 NTU unit in a second embodiment; no more than 0.5 NTU unit in a third embodiment; and no more than 0.2 NTU unit in a fourth embodiment.

This clarified water is used as feed to the membrane purification system. In one embodiment, the clarified water has a TDS content of greater than 5000 mg/L; in another embodiment, greater than 2000 mg/L; in another embodiment, greater than 1000 mg/L.

An antiscalant may be added to the water prior to going through the RO system to prevent fouling of the RO filter. Examples of antiscalants include HCl, sulfuric acid, or other types of acids, and/or conventional scale inhibitors. Additionally, a decarbonator unit may be added prior to water softening, after water softening but prior to the RO system, or after the RO system.

The RO system comprises an RO membrane, or a combination of RO and NF membranes. The RO membrane may also be a high recovery RO membrane and/or a high temperature RO membrane. In some cases, more than one RO module may be linked to other RO modules, either in parallel, in series, or using a combination thereof. The recovery percentage of the water may also be increased by recycling the concentrate (reject) water from RO modules later in the line back into the influx lines of previous RO modules.

Further, in a high temperature environment, such as steam flood, a high temperature RO/NF (reverse osmosis or nanofiltration) membrane system is used to conserve energy, reduce hardness and TDS. The energy savings is significant in comparison with the use of traditional RO/NF membranes whereas the maximum tolerance temperature is 113 F, while high temperature membranes can have a tolerance temperature of 120-210 F, for example. In some embodiments, a cooling system would not be need when using a high temperature membrane system. In some embodiments, the high RO membranes have recovery of up to 75% using partial softening to protect the fouling and scaling in the membrane elements. In some embodiments, with the high recovery and reduction of TDS and hardness, the high temperature membranes permeate water can reach boiler quality water level of <20 ppm TDS.

After running through the partial water softening system followed by the RO system, the water (termed “purified water”) may then be supplied as feed water to a boiler or once-through steam generator (OTSG). For example, an OTSG could provide up to 75-80% quality steam, and a boiler could provide 97% or better quality steam for a more effective steam flood, given water that was processed through partial softening and RO.

The methods of the disclosure may be performed either on-shore or off-shore, and may be adjusted to make the most efficient use of the location. As an example, ion exchange water softening systems may be used off-shore in order to reduce the amount of chemicals and waste solids that need to be transported to and from the rig.

Membrane purification is a membrane-based separation process that processes the clarified water as feed to make the purified water product. Membrane purification removes particulates, hardness, TDS, and free and dissolved oil to the low levels required of the purified water.

A membrane purification system that is used in the method may include ultrafiltration membranes, reverse osmosis membranes, or a combination of the two, in any order. The membrane purification system may include one or more membrane modules, with each module including a plurality of membrane elements. In general, a membrane element is taken to represent one membrane. The number and type of membranes within a particular module may be the same or different. Likewise, the number and type of membranes within a membrane system may be the same or different. In one embodiment, the clarified water feed to membrane purification contains greater than 100,000 ppm TDS (e.g. in a range from 100,000 to 200,000 ppm TDS), and ultrafiltration membranes are employed in the membrane purification system. In a second embodiment, the clarified water feed contains less than 100,000 ppm TDS, and RO membranes are employed for purification.

The membrane purification system may include a plurality of membrane modules in series flow, with one stream from a module being passed in series flow to the next module in the series, and with a second stream from the module being recovered for further treatment, for disposal, or for other uses. In one embodiment, permeate is cascaded through the plurality of membrane modules in series flow, with the retentate from each module being recovered for disposal or further treatment. In a second embodiment, the retentate is cascaded through the plurality of membrane modules in series flow, and permeate is recovered from each module for further treatment or for use elsewhere. In a third embodiment, the system may include a plurality of membrane modules in parallel. Each train of modules in the parallel configuration may cascade a permeate stream or a retentate stream from one or more preceding modules in series flow.

In one embodiment, the membrane purification system is operated at conditions to remove both ammonia and boron from the clarified water. The embodiment includes the steps of passing the clarified water through a first membrane module comprising a plurality of membrane elements, wherein the clarified water contains at least ammonia and boron and has a pH in a range from 8 to 11.5; producing a first permeate stream and a first retentate stream from the first membrane module, wherein the boron remaining in the first permeate stream is less 25 mg/L; acid adjusting the first permeate stream to produce a second membrane module feed having a pH in a range from 3 to 9; passing the second membrane module feed to a second membrane module comprising a plurality of membrane elements; producing a second permeate stream and a second retentate stream from the second membrane module, wherein the ammonia remaining in the second permeate stream is less than 25 ppm, and recovering a purified water, having less than 1 ppm hardness from the membrane purification system.

In one embodiment, the pH in the first membrane module is in a range from 9 to 11.5. In one embodiment, the pH in the second membrane module is in a range from 5 to 7.9. The boron remaining in the first permeate stream is less than 5 mg/L in a second embodiment; less than 1 mg/L in a third embodiment; and less than 0.5 mg/L in a fourth embodiment. The ammonia remaining in the second permeate stream is less than 10 ppm in a second embodiment; and less than 5 ppm in a third embodiment.

In another embodiment, the order of boron and ammonia separation from the clarified water is reversed, with the ammonia being removed from the first permeate stream at a pH in a range from 3 to 9 in one embodiment; and from 5 to 7.9 in a second embodiment. Boron is removed from the second permeate stream at a pH in a range from 8 to 11.5 in one embodiment; and from 9 to 11.5 in a second embodiment.

In one embodiment, the method for purifying the clarified water from a pretreatment process includes managing the potential for scale formation and membrane degradation within the membrane purification system. In this embodiment, at least one membrane element is monitored for the development of increased turbidity or increased scaling within the membrane element or within the retentate stream that is passed to the membrane element from a preceding element. When an undesirable operation is detected within one or more membrane elements, the feed to the element is treated to reduce turbidity and scaling tendency of the feed. In one embodiment, at least a portion of the feed to the element is recycled to the feed to the membrane module of which the membrane element is a member. In one embodiment, at least a portion of the feed to the element is treated in-situ by one or more of filtering, pH adjustment, purified water addition to reduce the concentration of the sources of turbidity and scaling, addition of antiscalant, and partial softening. In one embodiment, at least a portion of the feed to the membrane element is removed to a separate clarification module for conducting the treatment. Again, one or more of filtering, pH adjustment, coagulation, seeding, purified water addition to reduce the concentration of the sources of turbidity and scaling, addition of antiscalant, and partial softening may be used. The clarified feed to the element is recycled to the module for further processing.

One embodiment of the method includes passing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series; selecting a membrane element in contact with the retentate fraction as feed that has a turbidity that exceeds 0.5 NTU units; treating at least a portion of the feed retentate fraction to the select membrane element and restoring the turbidity of the feed retentate fraction to no more than 0.5 NTU units.

In one embodiment, treatment includes removing at least a portion of the retentate fraction from the select membrane element; settling the removed retentate fraction in a clarification module and recovering clarified water having a turbidity of at most 0.5 NTU units and a solid waste; and returning the clarified water to the membrane module.

In one embodiment, treatment includes adding a coagulant to the retentate fraction in the clarification module. The coagulant may be selected, for example, from sodium hydroxide and potassium hydroxide. Alternatively, the coagulant may be selected, for example, from ferric chloride, ferric sulfate, aluminum sulfate, polyaluminum chloride or other forms of iron or aluminum.

In one embodiment, treatment includes filtering the clarified water from the clarification module and passing the filtered clarified water to the select membrane element. In one embodiment, treatment includes adding fresh or purified water to the clarification module.

The feed to the membrane element may be treated in-situ, including adding fresh or purified water to the retentate fraction in contact with the select membrane element; adjusting the pH of the retentate fraction in contact with the select membrane element; or by recycling at least a portion of the retentate fraction in contact with the select membrane element to the clarified water that is the feed to the at least one membrane module.

In one embodiment, managing the potential for scale formation and membrane degradation within the membrane purification system includes directing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series. During operation of the membrane module, an acidic chemical is provided to each membrane element for reducing the pH of the retentate feed fraction to each element. While any acidic chemical in principle may be used, simple minerals acids such as hydrochloric or sulfuric acid are generally effective for reducing the scaling tendencies of the retentate feed fraction. Conventional antiscalants or scale inhibitors may also be provided to the membrane elements, either alone or in combination with an acidic chemical.

The amount of acidic additive provided may be the same for each membrane element in a module, or it may be different, depending on the particular set of operating conditions. The amount may be determined by modeling, which provides an estimate of the concentration and type of dissolved solids in the retentate feed fraction. The amount may be determined by monitoring devices adjacent to one or several of the membrane elements within the module. A turbidity monitor or pH monitor are two exemplary monitoring devices that may be used. The amount of acidic additive may be selected to maintain the turbidity of the retentate feed fraction to the membrane element at less than 0.5 NTU units. The amount of acidic additive may be sufficient to maintain the pH of the retentate feed fraction at less than 6 pH units (e.g. in a range from 3 to 6 pH units).

The purified water from the method contains less than 5 mg/L boron in one embodiment; less than 1 mg/L boron in a second embodiment; and less than 0.5 mg/L boron in a third embodiment. The purified water contains less than 25 mg/L ammonia In one embodiment; less than 10 mg/L ammonia in a second embodiment; and less than 5 mg/L ammonia in a third embodiment. The purified water contains less than 5 ppm hardness in a first embodiment; less than 1 ppm hardness in a second embodiment; less than 0.5 ppm hardness in a third embodiment; and less than 0.01 ppm hardness in a fourth embodiment. The purified water contains less than 100 ppm TDS in one embodiment; less than 10 ppm TDS in a second embodiment; and less than 1 ppm TDS in a third embodiment. The purified water has a pH in a range from 3 to 9 in one embodiment; from 5 to 7.9 in a second embodiment; and from 6 to 7.8 in a third embodiment. The purified water contains less than 10 ppm oil in one embodiment; less than 5 ppm oil in a second embodiment; and less than 2 ppm oil in a third embodiment. In a fourth embodiment, oil in the purified water is below the detection limit for free and dissolved oil. The purified water has a turbidity of no more than 1.5 NTU unit in one embodiment; no more than 1.0 NTU unit in a second embodiment; no more than 0.5 NTU unit in a third embodiment; and no more than 0.2 NTU unit in a fourth embodiment.

The purified water contains no particulates of size larger than 1 nm in one embodiment; and no particulates of size larger than 0.5 nm in a second embodiment; and no particulates of size larger than 0.1 nm in a third embodiment. The purified water contains less than 50 mg/L silica in one embodiment; less than 30 mg/L silica in a second embodiment; in a range from 0.05 to 50 mg/L silica in a third embodiment; and in a range from 1 to 30 mg/L silica in a fourth embodiment.

In one embodiment, the water treatment system is provided with a plurality of sensors to monitor the quality of the water in-between the process steps, e.g., the pretreated water stream, the water from the membrane filtering system, the reject stream, etc. The feedback from the sensor provides control parameters for one or more process steps to ensure the quality of the water feed and the purified water from the membrane system. Sensors include but are not limited to conductivity sensors, turbidity sensors, particulate sensors, and pH sensors.

Turbidity can be generally measured by using a turbidity meter, for example, a Hach Co. Model 2100 P Turbidimeter. A turbidity meter is a nephelometer that consists of a light source that illuminates a water/oil sample and a photoelectric cell that measures the intensity of light scattered at a 90° angle by the particles in the sample. A transmitted light detector also receives light that passes through the sample. The signal output (units in nephelometric turbidity units or NTUs) of the turbidimeter is a ratio of the two detectors. Meters can measure turbidity over a wide range from 0 to 1000 NTUs. The instrument must meet US-EPA design criteria as specified in US-EPA method 180.1.

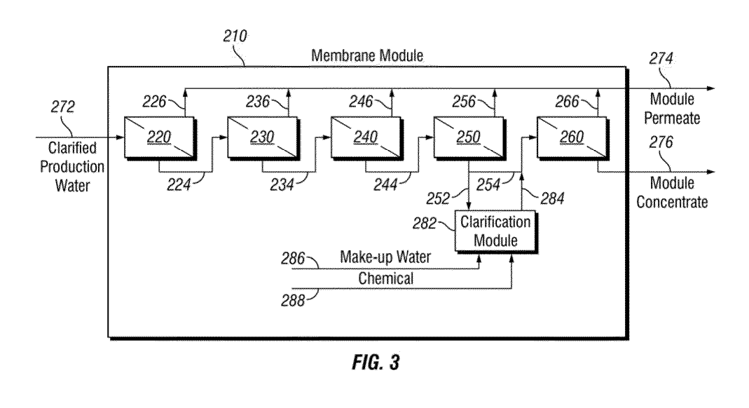

FIG. 3 illustrates, in another embodiment, a method for mitigating membrane scaling and fouling during operation of an exemplary membrane module 210. In FIG. 3, feed stream 272 to membrane module 210 may be clarified water from pretreatment, optionally combined with one or more recycle streams, or may be passed to the module from a preceding module in series flow.

Feedstream 272 is passed to membrane element 220; each succeeding membrane element 230, 240, 250 and 260 after membrane element 220 receiving a retentate 224, 234, 244, and 254 from the preceding membrane element as feed, wherein the concentration of contaminants in the retentate increases as the stream cascades past each of the plurality of membrane elements in series flow. Permeate streams 226, 236, 246, 256 and 266 from membrane elements 220, 230, 240, 250 and 260 combine to form module permeate stream 274. In this illustrative embodiment, the contaminant composition in the retentate in contact with a select element (e.g. element 250 in FIG. 3) exceeds the solubility concentration for at least one compound in the retentate, and an analysis shows that the retentate has a turbidity of greater than 0.2 NTU units, indicating the increased probability of scaling occurring on membrane element 150 and/or a succeeding elements. In one embodiment, retentate having a turbidity of greater than 1.5 NTU units, and in another embodiment greater than 1.0 NTU units, and in another embodiment greater than 0.2 NTU units triggers a mitigation step to reduce the turbidity. In the FIG. 3 example, the turbidity target is achieved by treating at least a portion of the retentate stream 254 that is in contact with membrane element 250 and restoring its turbidity to no more than 0.2 NTU units.

Treating at least a portion of the contaminant-enriched stream that is in contact with membrane element 250 includes removing at least a portion of the retentate fraction from the select membrane element 250 through stream 252, clarifying the removed retentate fraction in a clarifying module 282 and recovering a clarified water 284 having a turbidity no more than 1.5 NTU unit in one embodiment; no more than 1.0 NTU unit in a second embodiment; no more than 0.5 NTU unit in a third embodiment; and no more than 0.2 NTU unit in a fourth embodiment.

Clarified water 284 is returned to the RO membrane module 210 for further processing. The illustration in FIG. 3 shows the clarified water recycle 284 being passed to retentate 254.

In one embodiment, clarification module 282 is a holding vessel, for permitting the particulate matter in retentate 252 to settle, to produce a clarified recycle stream 284. In one embodiment, clarification module 282 comprises a filter medium for removing particulate matter from the retentate; the method includes filtering the clarified water from the clarification module 282 and passing the filtered clarified water 284 to the select membrane element 250.

Suitable filter media include absorption (e.g. a nutshell bed) ultrafiltration and nanofiltration. In one embodiment, fresh or purified water 286 is added to the retentate for improved clarity, to decrease the concentration of those materials in 252 that have exceeded the solubility limit. The purified water 286 may be recovered, at least in part, from the water purification method. In one embodiment, chemical 288 is added to adjust the pH of the retentate for improved clarity. Depending on the particular application, the chemical may be acid or alkaline. Illustrative, non-limiting alkaline chemicals include caustic or sodium hydroxide; soda ash or sodium carbonate in anhydrous or in one or more of the hydrated forms; lime or one or more of its constituents, including calcium oxide, calcium hydroxide and calcium carbonate in any of the various anhydrous or hydrated forms in which these materials occur; and magnesium oxide. In one embodiment, the alkaline chemical is a coagulant selected from sodium hydroxide, potassium hydroxide or combinations thereof. In one embodiment, the coagulant is selected from the group consisting of ferric chloride, ferric sulfate, aluminum sulfate, polyaluminum chloride or other forms of iron or aluminum. In one embodiment, the pH of contaminant-enriched stream 252 passed to the clarification module 282 has a pH in a range from 5.0 to 7.9. In one embodiment, the pH of the contaminant-enriched material in clarification module 282 is increased to a pH in a range from 8 to 11.5, and in another embodiment in a range from 9 to 11.5, and in another embodiment in a range from 5 to 7.9, to facilitate clarification of the retentate in clarification module 282. In one embodiment, a combination of these mitigation methods is applied.

In one or more embodiments, streams are added directly to the select membrane element for mitigating scaling within the module. In one embodiment, the step of treating at least a portion of the retentate fraction comprises adding fresh or purified water to the retentate fraction in contact with the select membrane element, thereby restoring the turbidity of the retentate fraction to no more than 0.2 NTU units (in one embodiment at most 1.0 NTU units; in one embodiment at most 1.5 NTU units). In one embodiment, the step of treating at least a portion of the contaminant-enriched stream comprises adjusting the pH of the retentate fraction in contact with the select membrane element by adding an alkaline chemical thereto, thereby restoring the turbidity of the contaminant-enriched stream to no more than 0.2 NTU units (in one embodiment at most 1.0 NTU units; in one embodiment at most 1.5 NTU units). In one embodiment, the contaminant-enriched stream is adjusted to a pH in a range from 9 to 11.5.

In one embodiment, the clarified recycle retentate 284 has a turbidity of no more than 1.5 NTU unit in one embodiment; no more than 1.0 NTU unit in a second embodiment; no more than 0.5 NTU unit in a third embodiment; and no more than 0.2 NTU unit in a fourth embodiment. In one embodiment, the clarified recycle retentate 284 has a pH of less than 6; in another embodiment in a range from 3 to 6.

### Examples

The following examples are included to demonstrate specific embodiments of the disclosure. It should be appreciated by those of skill in the art that the techniques disclosed in the examples that follow represent techniques discovered by the inventors to function well in the practice of the invention, and thus, can be considered to constitute modes for its practice. However, those of skill in the art should, in light of the present disclosure, appreciate that many changes can be made in the specific embodiments disclosed and still obtain a like or similar result without departing from the spirit and scope of the invention.

### Example 1

### Simulation of Partial Water Softening

A simulation of partial water softening was run using programs specifically designed by membrane companies for the specific membrane used.

Parameters:
1. Water Analysis: Simulated produced water was used for the software programs for membrane calculations.
2. Boiler Water Requirement: 207,000 BWPD for the treated produced water to meet the boiler water specifications. For the produced water, this would require approximately 300,000 BWPD for the RO membrane system, if the recovery factor is about 69-70%.
3. Water Temperature: A temperature not exceeding 45° C. (113° F.) was used for this study. 113° F. is the maximum tolerance temperature for the RO membranes used in this example.

The results showed that with a two-pass RO membrane process, with recycling of the 2^{nd} pass concentrate (reject) stream, recovery was 73% (Table 2). The quality of water was reached TDS of 4.85 ppm with only 0.01 ppm of calcium (no magnesium, strontium, barium), this calcium would be equivalent to 0.025 ppm of total hardness (Table 2).

Table 1 below contains the results of the first pass in a high-recovery low pressure RO membrane process simulation with RO recycling.

TABLE 1
Pass Streams
(mg/L as Ion)

| | | Adjusted Feed | | | | |
|---|---|---|---|---|---|---|
| | | | After | Concentrate | Permeate | |
| Name | Feed | Initial | Recycles | Stage 1 | Stage 1 | Total |
| NH₄+ + | 0.00 | 0.00 | 0.00 | 0.00 | 0.00 | 0.00 |
| NH₃ | | | | | | |
| K | 89.45 | 89.45 | 74.84 | 336.08 | 1.21 | 1.21 |
| Na | 1137.71 | 1137.71 | 950.71 | 4274.70 | 13.82 | 13.82 |
| Mg | 213.61 | 213.61 | 177.01 | 802.75 | 0.64 | 0.64 |
| Ca | 925.09 | 925.09 | 766.51 | 3476.50 | 2.69 | 2.69 |
| Sr | 35.12 | 35.12 | 29.10 | 131.98 | 0.10 | 0.10 |
| Ba | 0.00 | 0.00 | 0.00 | 0.00 | 0.00 | 0.00 |
| CO₃ | 8.54 | 8.54 | 5.39 | 144.89 | 0.00 | 0.00 |
| HCO₃ | 1072.63 | 1072.63 | 900.58 | 3801.04 | 14.30 | 14.30 |
| NO₃ | 0.00 | 0.00 | 0.00 | 0.00 | 0.00 | 0.00 |
| Cl | 12491.55 | 2556.10 | 2127.39 | 9604.91 | 19.81 | 19.81 |
| F | 0.00 | 0.00 | 0.00 | 0.00 | 0.00 | 0.00 |
| SO₄ | 1264.32 | 1264.32 | 1045.90 | 4751.45 | 1.47 | 1.47 |
| SiO₂ | 16.47 | 16.47 | 13.86 | 61.87 | 0.32 | 0.32 |
| Boron | 2.23 | 2.23 | 2.42 | 6.93 | 1.15 | 1.15 |
| CO₂ | 39.87 | 39.87 | 40.28 | 98.42 | 48.62 | 48.62 |
| TDS | 7267.23 | 7331.77 | 6105.13 | 27425.75 | 60.95 | 60.95 |
| pH | 7.28 | 7.28 | 7.22 | 7.25 | 5.59 | 5.59 |

Table 2 below contains the results of the second pass in a high-recovery low pressure RO membrane process simulation with RO recycling.

TABLE 2
Pass Streams
(mg/L as Ion)

| | | | Concentrate | Permeate | |
|---|---|---|---|---|---|
| Name | Feed | Adjusted Feed | Stage 1 | Stage 1 | Total |
| NH₄+ + NH₃ | 0.00 | 0.00 | 0.00 | 0.00 | 0.00 |
| K | 1.21 | 1.21 | 5.34 | 0.02 | 0.02 |
| Na | 13.82 | 13.82 | 60.79 | 0.17 | 0.17 |
| Mg | 0.64 | 0.64 | 2.82 | 0.00 | 0.00 |
| Ca | 2.69 | 2.69 | 11.90 | 0.01 | 0.01 |
| Sr | 0.10 | 0.10 | 0.45 | 0.00 | 0.00 |
| Ba | 0.00 | 0.00 | 0.00 | 0.00 | 0.00 |
| CO₃ | 0.00 | 0.00 | 0.01 | 0.00 | 0.00 |
| HCO₃ | 14.30 | 14.30 | 62.53 | 1.45 | 1.45 |
| NO₃ | 0.00 | 0.00 | 0.00 | 0.00 | 0.00 |
| Cl | 19.81 | 19.81 | 87.30 | 0.19 | 0.19 |
| F | 0.00 | 0.00 | 0.00 | 0.00 | 0.00 |
| SO₄ | 1.47 | 1.47 | 6.53 | 0.00 | 0.00 |
| SiO₂ | 0.32 | 0.32 | 1.41 | 0.04 | 0.01 |
| Boron | 1.15 | 1.15 | 3.30 | 0.52 | 0.52 |
| CO₂ | 48.62 | 48.62 | 48.71 | 47.75 | 47.74 |
| TDS | 60.95 | 60.95 | 257.98 | 4.85 | 4.85 |
| pH | 5.59 | 5.59 | 6.19 | 4.65 | 4.65 |

### Example 2

### Chemical Softening Testing

Based on a field application, results show that with the chemical softening method the use of a thickener-clarifier operation with a sophisticated UF filtration system, such as ceramic membranes for removing oil and solids in feed water of RO membrane application, may not be needed. Laboratory bottle and pilot tests were done to demonstrate the use of caustic, soda ash, or their combination, for partial softening of a produced water. In this case, the turbidity of water could be reduced to 0.2 Nephelometric Turbidity Units (NTU), which is suitable for the RO membrane operation.

Testing used a synthetic water with 3800 ppm of hardness and about 8000 ppm of TDS. The test procedure and results of each step are summarized as follows:

1. With 100 ml of the synthetic water, 5 drops of crude oil was added;

2. The sample was shaken 300 times in a prescription bottle;

3. Measured turbidity was 5 NTU

4. Temperature was 93° C. in a water bath for 1 hour;

5. Added 2200 ppm of sodium carbonate and mixed, the turbidity was 8 NTU;

6. Total hardness was reduced from 3360 ppm to 1613 ppm with 52% reduction.

7. After settling for 2 hours, the turbidity reduced from 8 to 0.21 NTU.

The results are summarized as follows:
1. In this case, an evaporation test shows that in order to have 75% water recovery without scaling about 50% original hardness should be removed.
2. Scale inhibitors are effective. Without the chemical scale tends to develop rapidly.
3. Caustic and soda ash can reduce half of the original hardness. A lower amount of caustic than soda ash can reduce the same amount of hardness, and produces a less amount of precipitates respectively.
4. For water containing oil particles, after treatment by either caustic or soda ash, the water quality is much better than controls (no soda ash or caustic). Further, soda ash treated water is better than caustic treated water; however, precipitates from adding soda ash tend to be more dense and stick to the bottom of prescribed glass bottles.
5. Higher temperature seems to help with clarifying oily water. As now with a temperature of 93 Celsius and a settling time of 3.5 hrs. The water turbidity treated by soda ash is 0.55 (initially 8).
6. Extensive settling might not be necessary at 93 Celsius. With initial turbidity 5.0, after two hours the turbidity is 0.21.

The above testing results show that the use of soda ash could reach a turbidity level of 0.2 NTU in 2 hours settling in a clarifier. This 0.2 NTU turbidity was established in testing for the treated water to be suitable for RO membrane operation.

The above testing results also show that partial softening is effective to reduce the total hardness to approximately 50% for a sample of produced water using scale inhibitors. Since the partial softening RO system increases the concentration of ions in the reject (concentrate) water, the concentration of hardness materials increases with the concentration increase. That is, when running a RO/NF membrane system at 50% recovery, the concentration of the ions will increase roughly by 50%. Hence, a way of handling this increase is decreasing the hardness by 50% prior to RO purification. When the hardness concentration decreases by 50%, then within the RO/NF system the ion concentration will increase about 50% when the system is run at 50% recovery. This technique effectively cancels the concentration effect of the increased hardness levels. It means that the concentration of hardness will keep the same as the feed water (before partial softening by 50%) throughout the RO/NF membrane system. Hence, this method minimizes the chemical treatment needed for scale control.

Additionally, the total softening process could also provide steam for the OTSG steam generator operations. The partial softening with RO membranes would also be able to supply feed water for boilers. The OTSG would provide up to 75-80% quality steam, and boiler would provide 97% or better quality steam for more effective steam flood.

### Example 3

### Partial Water Softening with a High Temperature Membrane

A GE high temperature reverse osmosis membrane was used in this example. The membrane used was a high temperature reverse osmosis membrane that can operate at up to 70° C. Using GE's Winflows software, simulations were conducted for both two pass and three pass system layouts. Determination of the maximum overall recovery and the lowest TDS was conducted based on a trial-and-error manner. Any configuration that yields system error (except scale-indicating errors, scale prevention will be addressed by partial softening) was excluded from further consideration. Feed composition was modified to reflect 50% hardness removal for partial softening. In addition to eliminating systematic errors, caution was taken for limiting the maximum cross sectional flow rate to be lower than 20 GFD as suggested by the manufacturer.

For the handling 300,000 B/D (or 8750 gpm) of produced water using a two pass design with a total number of 5080 elements in total. The line from the second pass reject stream was recycled back into the first RO input stream. The three pass design had a total number of 6688 elements. The concentrate from the second pass was recycled back to the feed stream. The concentrate from the third pass combined with the concentrate from the first pass to form the total concentrate.

As shown in Table 3 below, the two pass design recovered 4.2% more water than the three pass design does, however, the TDS was compromised by 15.62 mg/L. Temperature was set to 137 F which was the projected feed temperature achieved by using fin-fan cooler.

TABLE 3

| | | Permeate TDS at | | |
|---|---|---|---|---|
| Temp, | Temp | max recovery, | Overall recovery | |
| (° F.) | (° C.) | (mg/L) | (%) | Configuration |
| 137 | 58.3 | 19.68 | 67.2 | Two pass |
| 137 | 58.3 | 4.07 | 63 | Three pass |

For the avoidance of doubt, the present application includes the subject-matter defined in the following numbered paragraphs:

1. A method of improving the percent recovery in water with high levels of hardness, the method comprising:
a) receiving a produced water composition;
b) partially softening the water composition;
c) adding an antiscalant to the partially softened water composition; and
c) directing the partially softened water composition through at least one reverse osmosis unit.
2. The method of claim 1, further comprising directing the effluent from the reverse osmosis unit to a boiler or a once-through steam generator.
3. The method of claim 1, wherein the water composition has been previously processed to remove oil and gas.
4. The method of claim 1, further comprising using a decarbonator unit.
5. The method of claim 1, wherein the partially softened water composition is directed through two reverse osmosis units.
6. The method of claim 5, wherein the reject stream from the second reverse osmosis unit is recycled back to into the first osmosis unit.
7. The method of claim 1, wherein partially softening the water comprises using a chemical softener.
8. The method of claim 7, wherein the chemical softener is lime, soda ash, or a combination thereof
9. The method of claim 1, wherein partially softening the water comprises using an ion exchange resin based water softener.
10. The method of claim 9, wherein the water softener is a strong acid cation softener.
11. The method of claim 9, wherein the water softener is a weak acid cation softener.
12. The method of claim 1, wherein partially softening the water comprises reducing the hardness of the produced water composition by about 30-70%, about 40-80%, about 50-70%, or about 50-60%.
13. The method of claim 1, wherein partially softening the water composition comprises reducing the hardness of the produced water to at most about 10, about 25, about 50, about 100, about 200, about 300, about 400, about 500, about 750, about 1000, about 1500, about 2000, about 2500, about 3000, about 4000 or about 5000 ppm.
14. The method of claim 1, wherein the produced water composition comprises a TDS of greater than greater than 3000, greater than 4000, greater than 5000, greater than 6000, or greater than 7000.
15. The method of claim 1, wherein the partially softened water is cooled prior to directing the partially softened water composition through at least one reverse osmosis unit.
16. The method of claim 15, wherein the water is cooled to less than 100° C., less than 95° C., less than 93° C., less than 90° C., or less than 80° C.
17. The method of claim 7, wherein the produced water is heated prior to partially softening the water composition.
18. The method of claim 1, wherein the reverse osmosis unit is a high temperature reverse osmosis unit.
19. The method of claim 18, wherein the reverse osmosis unit has a maximum temperature of between 120 to 210° F.

### REFERENCES

All patents and publications mentioned in the specification are indicative of the levels of skill in the art to which the invention pertains. All patents and publication are herein incorporated by reference to the same extent as if each individual publication was specifically and individually indicated to be incorporated by reference.
U.S. Pat. No. 5,250,185.
U.S. Patent Application 2012/0255904
U.S. Pat. No. 5,683,587

What is claimed is:

1. A method of improving the percent recovery in a produced water composition with high levels of hardness, the method comprising:
directing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series;
treating the retentate feed fraction to each membrane element in the module to reduce the fouling tendency of each of the membrane elements; and
recovering a purified water from the membrane module,
wherein the clarified water is produced by a method comprising:
receiving a produced water composition, the produced water composition comprising a mixture of water, oil, and solids;
removing oil and solids from the produced water in at least one filter to recover a filtered water composition, wherein the filtered water composition contains particulates that are at most 5 μm in size and wherein the filtered water composition contains less than 5 ppm oil;
partially softening the filtered water composition by removing from 30-70% of the hardness contained therein to produce a partially softened water composition;
adding an antiscalant to the low turbidity water composition to form the clarified water.

2. The method of claim 1, further comprising monitoring the turbidity of the feed retentate fraction to each membrane element in the module.

3. The method of claim 1, wherein treating the retentate feed fraction includes maintaining the turbidity of the retentate feed fraction to each membrane element at less than 0.5 NTU units.

4. The method of claim 1, wherein treating the retentate feed fraction includes maintaining the pH of the retentate feed fraction of each membrane element at less than 6 pH units.

5. The method of claim 1, wherein treating the retentate feed fraction includes adding an antiscalant to the retentate feed fraction to each membrane element for a retentate feed fraction turbidity of less than 0.5 NTU units.

6. The method of claim 1, wherein treating the retentate feed fraction includes adding an acid to the retentate feed fraction to each membrane element for a retentate feed fraction pH of less than 6 pH units.

7. The method of claim 1, wherein the produced water composition has a hardness of over 1000 ppm.

8. The method of claim 1, wherein the filter comprises at least one of nutshell filter media, oyster shell filter media, sand, peat, shredded tires, foam, crushed glass, geo-textile fabric, crushed granite

9. The method of claim 1, wherein partially softening the filtered water composition includes at least one process selected from the group consisting of warm lime softening, cold lime softening, hot lime softening, magnesium oxide dosing, soda ash dosing, seeding and ion exchange.

10. The method of claim 1, wherein partially softening the filtered water composition comprises warm lime treating the filtered water composition.

11. The method of claim 10, further comprising polishing the purified water recovered from the membrane module in an ion exchange process

12. The method of claim 1, wherein partially softening the filtered water composition comprises ion exchange treating the filtered water composition.

13. The method of claim 1, wherein partially softening the filtered water composition comprises seeding the filtered water composition with an alkaline chemical, selected from sodium hydroxide, soda ash, sodium carbonate, calcium oxide, calcium hydroxide, calcium carbonate, magnesium oxide and combinations thereof.

14. The method of claim 1, further comprising settling the partially softened water in a clarification module having a hydraulic retention time of greater than 1 minute and recovering a low turbidity water composition therefrom having a turbidity of less than 0.5 NTU units

15. The method of claim 14, wherein the clarification module includes a cartridge filter for removing residual particulates contained in the partially softened water and recovering the low turbidity composition water having a turbidity of less than 0.5 NTU units.

16. The method of claim 1, further comprising partially softening the filtered water composition to a hardness in a range from 1 to 50 ppm.

17. The method of claim 1, wherein the antiscalant is an acid, and wherein the clarified water has a pH in a range from 5 to 7.9.

18. The method of claim 1, wherein the antiscalant is an acid, and wherein the clarified water has a pH in a range of less than 6.

19. The method of claim 1, wherein the membrane module comprises reverse osmosis elements.

20. A method of improving the percent recovery in a produced water composition with high levels of hardness, the method comprising:
directing clarified water through at least one membrane module comprising a plurality of membrane elements in series flow, each succeeding membrane element after the first receiving a retentate fraction from the preceding membrane element as feed, wherein the concentration of contaminants in the retentate fraction increases as the fraction cascades to each of the plurality of membrane elements in series;
treating the retentate feed fraction to each membrane element in the module to reduce the fouling tendency of each of the membrane elements; and
recovering a purified water from the membrane module,
wherein the clarified water is produced by a method consisting essentially of:
receiving a produced water composition, the produced water composition comprising a mixture of water, oil, and solids;
removing oil and solids from the produced water in at least one filter to recover a filtered water composition, wherein the filtered water composition contains particulates that are at most 10 μm in size and wherein the filtered water composition contains less than 10 ppm oil;
partially softening the filtered water composition by removing from 30-70% of the hardness contained therein to produce a partially softened water composition;
settling the partially softened water in a clarification module having a hydraulic retention time of greater than 1 minute and recovering a clarified water therefrom having a turbidity of less than 0.5 NTU units; and
adding an antiscalant to the partially softened water composition to form the clarified water.

21. The method of claim 1, wherein partially softening the filtered water composition consists essentially of warm lime treating the filtered water composition.

22. The method of claim 1, wherein partially softening the filtered water composition consists essentially of ion exchange treating the filtered water composition.

23. The method of claim 1, wherein partially softening the filtered water composition consists essentially of seeding the filtered water composition with an alkaline chemical, selected from sodium hydroxide, soda ash, sodium carbonate, calcium oxide, calcium hydroxide, calcium carbonate, magnesium oxide and combinations thereof.
